(19) United States
(12) Patent Application Publication
(10) Pub. No.: US 2026/0289981 A1
(43) Pub. Date: Sep. 24, 2026

(54) Configuring a Machine Learning Pipeline Based on Patch Context Robustness Indexes

(71) Applicant: Oracle International Corporation, Redwood Shores, CA (US)

(72) Inventors: Amit Agarwal, Seattle, WA (US); Srikant Panda, Bangalore (IN); Hitesh Laxmichand Patel, Jersey City, NJ (US); Hansa Meghwani, Bengaluru (IN); Avinash Rajeshchandra Rai, Bengaluru (IN)

(73) Assignee: Oracle International Corporation, Redwood Shores, CA (US)

(21) Appl. No.: 19/327,883

(22) Filed: Sep. 12, 2025

Related U.S. Application Data
(60) Provisional application No. 63/774,382, filed on Mar. 19, 2025.

(51) Int. Cl. G06V 10/776; G06V 10/70; G06V 10/94

(52) U.S. Cl. CPC G06V 10/776; G06V 10/87; G06V 10/955

(57) ABSTRACT

Techniques for configuring a machine learning (ML) pipeline are disclosed. One or more embodiments generate a patch context robustness index (PCRI) value that quantifies, for computer vision model (CVM), sensitivity of the CVM to contextual noise, at least by: determining a first performance metric at least by applying the CVM to a whole image; determining a second performance metric at least by applying the CVM to patches of the whole image; and determining the PCRI value as a function of at least the first performance metric and the second performance metric. One or more embodiments deploy the CVM to an ML pipeline based at least on the PCRI value.

### BENEFIT CLAIMS; RELATED APPLICATIONS; INCORPORATION BY REFERENCE

This application claims the benefit of U.S. Provisional Patent Application 63/774,382, filed Mar. 19, 2025, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to machine learning (ML) models. In particular, the present disclosure relates to ML models that process visual data.

### BACKGROUND

Different types of ML models are deployed in various settings to perform different tasks. Some ML models perform tasks that process visual data (e.g., photographs, video feeds, human-generated images, etc.). Examples of such ML models include, but are not limited to, visual language models (VLMs) and multimodal large language models (MLLMs). For ease of discussion, ML models that process visual data are referred to herein as computer vision models (CVMs), even if they also process other types of data. Visual data is also referred to herein as image data.

One challenge faced by CVMs is the presence of contextual noise and/or noisy visual information, such as cluttered backgrounds, irrelevant objects, and/or ambiguous visual cues. This noise can interfere with the model's ability to interpret visual features and respond to visual language tasks, leading to degraded performance, misinterpretation of prompts, hallucinated outputs, etc. CVMs often struggle to handle visual contexts and focus on relevant content when provided with irrelevant and/or noisy information.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an ML pipeline configuration system in accordance with one or more embodiments;

FIG. 2 illustrates an example set of operations for configuring an ML pipeline in accordance with one or more embodiments;

FIGS. 3A-F illustrate examples of performance metrics for ML pipeline configuration systems in accordance with one or more embodiments;

FIG. 4 illustrates an ML engine in accordance with one or more embodiments;

FIG. 5 illustrates the operation of an ML engine in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. PRACTICAL APPLICATIONS, ADVANTAGES, AND IMPROVEMENTS
3. CVM PIPELINE CONFIGURATION SYSTEM
4. OPERATIONS FOR CONFIGURING AN ML PIPELINE
5. PERFORMANCE METRICS FOR CVM PIPELINE CONFIGURATION SYSTEM
   5.1. PATCH GRANULARITY PERFORMANCE METRICS
   5.2. AVERAGE PATCH CONTEXT ROBUSTNESS INDEX
   5.3. MAXIMUM PATCH CONTEXT ROBUSTNESS INDEX
   5.4. PATCH CONTEXT ROBUSTNESS INDEX
   5.5 CVM PIPELINE DEPLOYMENT
   5.6 HIGH ROBUSTNESS CVM PIPELINE DEPLOYMENT
   5.7. NOISY PATCH CONTEXT ROBUSTNESS PERFORMANCE
6. ML ARCHITECTURE
7. ML OPERATIONS
8. GENERATIVE ARTIFICIAL INTELLIGENCE MODELS
9. COMPUTER NETWORKS AND CLOUD NETWORKS
10. MICROSERVICE APPLICATIONS
11. HARDWARE OVERVIEW
12. MISCELLANEOUS; EXTENSIONS

### 1. GENERAL OVERVIEW

One or more embodiments configure an ML pipeline based on a Patch Context Robustness Index (PCRI) value that quantifies a CVM's sensitivity to contextual noise. Specifically, one or more embodiments compute the relative performance difference between patch-based and full-image inputs. In an embodiment, a PCRI value quantifies a CVM's sensitivity to irrelevant information, such as its ability to handle varying levels of contextual noise. For example, depending on the specific formula, either higher or lower values indicate greater sensitivity to irrelevant information.

Responsive to determining that the PCRI value satisfies a threshold criterion, one or more embodiments deploy the CVM to a deployment environment. One or more embodiments select a CVM from among multiple candidate CVMs based on a comparison of the respective PCRI values for the candidate CVMs. Based on one or more PCRI values for one or more CVMs, one or more embodiments select one or more of the CVMs for deployment to an environment that may require and/or benefit from high robustness.

One or more embodiments configure at least part of an ML pipeline based on a task type-specific PCRI value associated with a particular task type. In some embodiments, type-specific PCRI values include one or more PCRI values for types of visual language tasks such as captioning, reasoning, question and answer, recognition (e.g., facial, optical character, etc.), anomaly detection, and/or other types of visual language tasks. One or more embodiments quantify a CVM's sensitivity to contextual noise when performing tasks of a particular type. Responsive to determining that the PCRI value satisfies a threshold criterion for a task type to be performed in a particular deployment setting, one or more embodiments deploy the CVM to the deployment setting. Based on one or more PCRI values for a task type, one or more embodiments select one or more CVMs for one or more deployment environments that may require and/or benefit from high robustness for that task type.

One or more embodiments described in this Specification and/or recited in the claims may not be included in this General Overview section.

### 2. PRACTICAL APPLICATIONS, ADVANTAGES, AND IMPROVEMENTS

One or more embodiments use PCRI values to improve the performance of an ML pipeline in one or more of the following ways.

One or more embodiments use PCRI values to identify, among multiple CVMs, a CVM that is best suited to a particular application. Specifically, one or more embodiments select the more capable and robust CVM(s) for the intended purpose. One or more embodiments act as a metrics gate for training, fine-tuning, evaluating, and/or deploying CVMs. In this context, a metrics gate evaluates one or more criteria that a CVM may be required to satisfy as a prerequisite for training, fine-tuning, further evaluating, and/or deploying the CVM. For example, one or more embodiments rank CVMs based on their robustness and ability to handle global context. One or more embodiments use the rankings to select a CVM based on its relative performance and/or capabilities.

One or more embodiments select a CVM to perform a particular task type based on a task-specific PCRI value. One or more embodiments perform the selection without human intervention. One or more embodiments improve system performance by reducing instances of using inefficient CVMs. Using inefficient CVMs consumes computing resources that could otherwise be used for other purposes.

One or more embodiments improve system performance by responding adaptively to different needs, thus supporting a variety of applications without needing to hard-code specific workflows for applications. Avoiding the need to hard-code specific workflows improves the functioning of the system by supporting applications of CVMs that may not have been anticipated when the system was developed.

One or more embodiments improve system performance by allocating resources selectively to an ML pipeline. An ML pipeline configuration engine selectively deploys CVMs based on the CVMs meeting an optimization criterion. CVMs that do not meet the optimization criterion may be adjusted. Selectively deploying CVMs and adjusting CVMs that do not meet an optimization criterion prevents wasting resources on adjusting CVMs that do not meet the optimization criterion. One or more embodiments deploy an adjusted CVM if the adjusted CVM meets the optimization criterion. Deploying optimized CVMs increases system performance by deploying a CVM that satisfies a particular level of robustness required by a particular deployment environment.

### 3. CVM PIPELINE CONFIGURATION SYSTEM

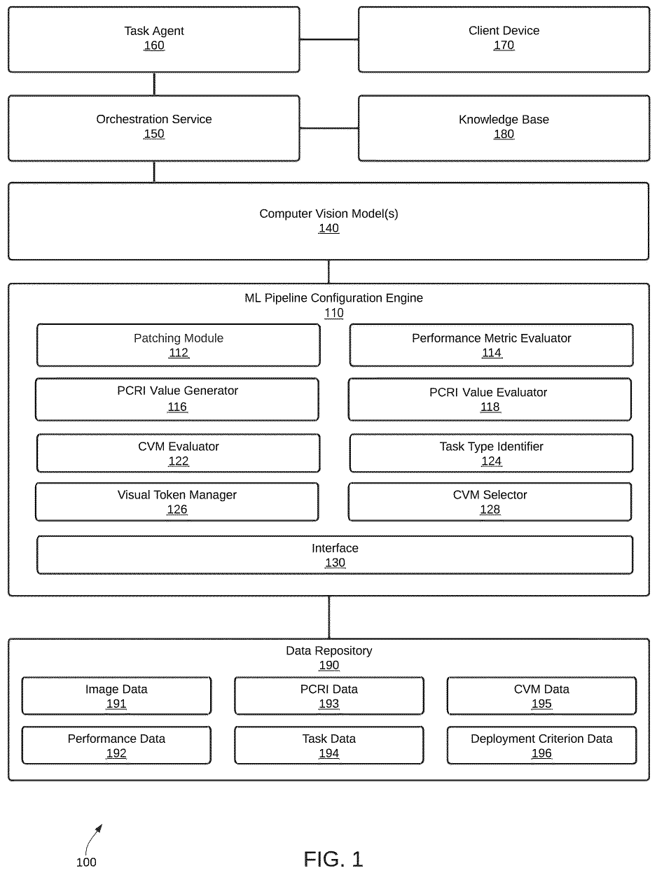

FIG. 1 illustrates an ML pipeline configuration system 100 in accordance with one or more embodiments. As illustrated in FIG. 1, CVM pipeline configuration system 100 includes an ML pipeline configuration engine 110, one or more CVMs 140, an orchestration service 150, a task agent 160, a client device 170, a knowledge base 180, and a data repository 190. The ML pipeline configuration engine 110 includes a patching module 112, a performance metric evaluator 114, a PCRI value generator 116, a PCRI value evaluator 118, a CVM evaluator 122, a task type identifier 124, a visual token manager 126, a CVM selector 128, and an interface 130.

In one or more embodiments, the ML pipeline configuration system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The patching module 112 is configured to divide image data into smaller, structured sections, referred to as patches. For example, to divide an image into patches, one or more embodiments may define a grid of patches that are rectangular areas, structured in rows and columns, that partition the image into non-overlapping sections. In some cases, the number of rows equals the number of columns, and the patches are equally sized. However, other shapes or configurations with unequal patch sizes or unequal numbers of rows and columns may also be used. The patching module 112 may be configured to segment and/or crop images into fixed or variable-sized squares or rectangles (or other shapes). The patching module 112 may be configured to standardize or prepare patches of image data from an image. The patching module 112 may be configured to maintain metadata about the location and/or source of a patch.

The performance metric evaluator 114 is configured to assess the performance of one or more CVMs 140 when performing tasks using a particular set of visual data. The performance metric evaluator 114 may be configured to calculate and report various quantitative metrics associated with a CVM 140's performance, accuracy, and/or quality. For example, the performance metric evaluator 114 may access results obtained from one or more CVMs 140 having performed one or more vision-related tasks. In one or more embodiments, the performance metric evaluator 114 evaluates a CVM 140's whole image performance for a task and/or a patch performance for the task for the CVM 140. Some examples of performance metrics include, but are not limited to, accuracy, precision, recall, F1 score, loss functions, and/or combinations thereof.

The PCRI value generator 116 is configured to compute PCRI values for a CVM 140. For example, the PCRI value generator 116 may calculate one or more PCRI values for a CVM 140 based on performance metrics related to the CVM 140's performance on certain tasks. In one or more embodiments, the PCRI value generator 116 generates average-based PCRI values and/or maximum-based PCRI values for one or more CVMs 140.

Specifically, one or more embodiments compute a proportionality constant k, which may be calculated as

$$k = \frac{{P}_{patch}}{{P}_{whole}}$$

where P_{patch} is the CVM performance using patches to perform a task and P_{whole} is the CVM performance using the whole image. In one or more embodiments, P_{patch} quantifies maximum patch performance for a set of patches and/or an average of individual patch performances for a set of patches. To compute a PCRI, one or more embodiments also apply one or more normalizing constants and/or additive or subtractive constants to k. For example, one or more embodiments may compute a PCRI as

$$PCRI = n \pm m \times k$$

where n is an additive or subtractive constant and m is a normalizing constant. Alternatively, or additionally, computing a PCRI value may include one or more other constant and/or variable values.

In an embodiment, the PCRI value generator 116 calculates a metric that is proportional to a quotient of a patch performance (e.g., a maximum patch performance or an average patch performance), divided by a whole image performance. One or more embodiments normalize the metric for a number of patches to generate a PCRI value. One or more embodiments use the PCRI value to quantify sensitivity to contextual noise and/or other irrelevant information.

In one or more embodiments, the PCRI value generator 116 generates one or more PCRI values based on a CVM 140's performance on a visual reasoning task. The PCRI value generator 116 may generate a PCRI value based on the CVM 140's performance for a whole image of the dataset and the CVM 140's performance for patches of the whole image of the dataset. In an embodiment, various datasets include any number of images. The PCRI value generator 116 aggregates values that indicate a CVM 140's performance on one or more tasks across a dataset, to obtain a combined or aggregated PCRI value. As described in further detail herein, the aggregated PCRI value indicates if the CVM 140's performance is sensitive to contextual noise.

The PCRI value evaluator 118 is configured to categorize a PCRI value based on the type of PCRI value and the PCRI value itself. For example, the PCRI value evaluator 118 may obtain one or more PCRI values and determine if the one or more PCRI values include maximum patch performance-based PCRI values and/or average patch performance-based PCRI values. The PCRI value evaluator 118 may determine if a particular PCRI value meets a requirement for a task or dataset. For one or more particular datasets, models, or tasks, the PCRI value evaluator 118 may determine one or more threshold PCRI values based on the datasets, models, and/or tasks. The PCRI value evaluator 118 may compare a particular PCRI value to the one or more thresholds to determine a category or type for a model, task, and/or dataset associated with the PCRI value.

For example, one or more embodiments may use multiple CVMs 140 to perform a visual reasoning task. One or more embodiments compute respective PCRI values based on the CVMs' 140 respective performances on the task. The PCRI value evaluator 118 may analyze the PCRI values to identify a CVM 140 that has the least sensitivity to contextual noise. In one or more embodiments, the PCRI value evaluator 118 analyzes a PCRI value to determine if the PCRI value satisfies one or more criteria. One or more embodiments evaluate PCRI values to determine, for example, whether or not to deploy a CVM 140.

In one or more embodiments, the PCRI value evaluator 118 analyzes a set of PCRI values to determine one or more of the following: a difference between a maximum-based PCRI value and an average-based PCRI value for a task or model, a threshold PCRI value that indicates high-robustness for a task or model, if one or more CVMs 140 are suited for filtering out background noise for a task, and/or if the set of PCRI values satisfies one or more other criteria.

The CVM evaluator 122 is configured to categorize a CVM 140 based on one or more PCRI values for the CVM 140 and/or based on a performance of the CVM 140 for datasets and/or tasks that have one or more PCRI values associated therewith. The CVM evaluator 122 analyzes a CVM 140's performance and PCRI values to typify and/or categorize the CVM 140. For example, a CVM 140 that consistently has PCRI values near zero, an average patch performance near a whole image performance, and a maximum patch performance near the whole image performance is considered a robust CVM 140 with an ideal-like attention mechanism. In one or more embodiments, the CVM evaluator 122 generates a context-sensitivity ranking for a set of one or more CVMs 140 based on one or more PCRI values for the one or more CVMs 140.

In an embodiment, the CVM evaluator 122 categorizes a CVM 140 as context-sensitive or as having a weak attention mechanism based on the CVM 140 being associated with an average-based PCRI value greater than zero and a maximum-based PCRI value much greater than zero. In another example, the CVM evaluator 122 determines that a CVM 140 is context-sensitive based on an average patch performance being better (e.g., greater or lesser, depending on how the PCRI is calculated) than a whole image performance and a maximum patch performance being much greater than a whole image performance.

The task type identifier 124 is configured to receive a task or task description and determine one or more types associated with the task. In some embodiments, the type associated with a task indicates a type of reasoning or result associated with the task. For example, different types of tasks include captioning, yes/no answering, multiple-choice answering, visual reasoning tasks, optical character recognition tasks, etc. In some embodiments, the type associated with a task indicates a sensitivity of the task to background noise and/or other irrelevant information. For example, different types of tasks include highly sensitive tasks, sensitive tasks, non-sensitive tasks, etc. For example, the task type identifier 124 may determine that tasks performed in a particular deployment setting, also referred to as a deployment environment (e.g., a server, data center, virtual machine, container, etc.), are sensitive to contextual noise. In this example, the task type identifier 124 identifies the tasks that are sensitive to contextual noise as requiring high robustness.

In this context, a yes/no question task prompts a CVM 140 to determine if a given statement or query can be affirmed or denied based on an image. A CVM 140 may respond with a binary response, such as yes or no. A multiple-choice question task presents a query along with several candidate answers, and a CVM 140 may select one of the options based on an image. A visual question answering task prompts a CVM 140 to answer a natural language question based on the content of an image. A captioning task prompts a CVM 140 to generate a coherent natural language description that summarizes the content or key elements of image data. A diagram understanding task prompts a CVM 140 to interpret structured visual representations, such as flowcharts, maps, or scientific diagrams. A compositional reasoning task prompts a CVM 140 to solve a problem that may require combining multiple pieces of information. For example, a problem may require information from multiple patches of image data. An optical character recognition task prompts a CVM 140 to identify and transcribe text that appears within image data. A logical reasoning task prompts a CVM 140 to draw conclusions, detect inconsistencies, and/or evaluate propositions based on image data. Different types of logical reasoning tasks may be answerable by yes/no, multiple choice, or open-ended responses.

The visual token manager 126 is configured to generate, store, organize, and delete visual tokens encoded from visual data. The visual token manager 126 manages the assignment, indexing, and retrieval of visual tokens for different tasks, like captioning or visual reasoning. In one or more embodiments, the visual token manager 126 is configured to selectively deploy visual encoders to encode selected visual data into tokens. The visual token manager 126 may be configured to prune visual tokens with irrelevant information. In some embodiments, the visual token manager 126 selectively deploys visual encoders to selectively encode visual data, located in one or more particular patches of an image, into tokens based on relevant text associated with the task. The visual token manager 126 may be configured to relate image tokens to source images and/or patches of source images.

The CVM selector 128 is configured to select one or more CVMs 140 for deployment, training, or fine-tuning based on respective PCRI values associated with the one or more CVMs 140. The CVM selector 128 may be configured to compare one or more PCRI values for different CVMs 140 to determine which CVM 140 to choose for a particular deployment. In one or more embodiments, the CVM selector 128 selects a CVM 140 based on different thresholds associated with different target deployments. The CVM selector 128 may select a CVM 140 for training, benchmarking, and/or deployment based on a robustness requirement for a deployment setting. For example, the CVM selector 128 may determine if CVM 140 satisfies a threshold PCRI value criterion and/or a performance metric criterion.

In one or more embodiments, interface 130 refers to hardware and/or software configured to facilitate communications between a user and the ML pipeline configuration system 100. Interface 130 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 130 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 130 is specified in one or more other languages, such as Java, C, or C++.

In an embodiment, some or all the CVMs 140 share an embedding space for text and image data and cross-modal attention mechanisms that align and relate information across the different data types within the embedding space. Some examples of CVMs 140 include contrastive language-image pretraining (CLIP) models, Flamingo models, and generative pre-trained transformer models such as GPT-4V. In this context, a Flamingo model is a type of model designed for few-shot learning that is capable of processing interleaved visual and textual data to perform various tasks with minimal examples. The one or more CVMs 140 are accessible to components of the orchestration service 150 and are configured to process input retrieved from client device 170 and/or knowledge base 180.

The orchestration service 150 is configured to orchestrate or coordinate operation of other components of the ML pipeline configuration engine 110 by performing tasks such as routing queries, invoking a CVM 140, managing subsequent input next tasks or for model improvement, etc. For example, the orchestration service 150 may communicate with the task agent 160, the CVM(s) 140, and/or the knowledge base 180 to perform response generation based on an input from client device 170. In some embodiments, the orchestration service 150 is configured to select a CVM 140 based on a task type.

In an embodiment, the task agent 160 is configured to receive input from the client device 170 and use one or more ML models to generate one or more tasks based on those inputs. The task agent 160 may use the orchestration service 150 to select and utilize one or more CVMs 140 to perform the task(s). The task agent 160 may be configured to perform various task-related functions such as generating tasks, retrieving information from the knowledge base 180 and/or interfacing with another retrieval system, formulating a final response, etc. In some embodiments, the task agent 160 interacts with the client device 170 to receive image uploads and/or issues commands to perform image captioning or visual analysis tasks on the uploaded images.

The client device 170 is a user-facing hardware component used to interface with the task agent 160. Some examples of client devices 170 include smartphones, tablets, desktop computers, and other devices that support user input and output. The client device 170 facilitates the transmission of text and/or multimodal inputs, such as images and text, from a user's computing environment to the orchestration service 150. The client device 170 includes components for wireless or wired communication, input capture (e.g., touchscreens, cameras, microphones), display output, etc. In some cases, the client device 170 is the source of image uploads that a CVM 140 processes via the orchestration service 150.

In an embodiment, the knowledge base 180 is a structured data repository that includes information such as curated datasets, vector databases, image stores, document repositories, and/or the like. In an embodiment, the knowledge base 180 supports retrieval-augmented generation (RAG). The knowledge base 180 stores data, such as domain-specific reference material, annotated images, question-answer pairs, and other structured content. The knowledge base 180 may be accessible to the orchestration service 150 and/or the CVM(s) 140 to support context-aware processing, image-based inference, and/or content augmentation during task execution by the task agent 160.

In an embodiment, the data repository 190 is configured to store image data 191, performance data 192, PCRI data 193, task data 194, CVM data 195, deployment criterion data 196, and/or other data generated and/or accessed by the ML pipeline configuration system 100.

In one or more embodiments, a data repository 190 is any type of storage unit and/or device (e.g., a file system, database, collection of tables, or any other storage mechanism) for storing data. Furthermore, a data repository 190 may include multiple different storage units and/or devices. The multiple different storage units and/or devices may or may not be of the same type or located at the same physical site. Furthermore, a data repository 190 may be implemented or executed on the same computing system as other components of the ML pipeline configuration system 100. Additionally, or alternatively, a data repository 190 may be implemented or executed on a computing system separate from other components of the ML pipeline configuration system 100. The data repository 190 may be communicatively coupled to one or more other components of the ML pipeline configuration system 100 via a direct connection or via a network.

Information describing the image data 191, performance data 192, PCRI data 193, task data 194, CVM data 195, and/or deployment criterion data 196 may be implemented across any of components within the ML pipeline configuration system 100. However, this information is illustrated within the data repository 190 for purposes of clarity and explanation.

Image data 191 refers to image/visual data such as photographs, videos, human-generated images, etc. For example, image data 191 may include portable network graphics (PNG) data, graphics interchange format (GIF) data, bitmap (BMP) data, audio video interleave (AVI) data, moving picture experts group (MPEG) data, etc. In some cases, image data 191 may include still images corresponding to frames extracted from video data.

The performance data 192 refers to accuracy, precision, correctness, F1, and/or other scores or metrics determined based on a CVM 140's performance on a task involving one or more images and/or one or more portions of one or more images. The performance data 192 may include performance scores for a whole image and/or performance scores for patches of the whole image.

In one or more embodiments, the PCRI data 193 includes stored PCRI values and/or information related to PCRI values. For example, PCRI data 193 may include a PCRI value calculated for a CVM 140 using a visual dataset to perform a task. PCRI data 193 may include other PCRI values calculated for CVM 140 using other visual datasets to perform other tasks. In some embodiments, PCRI data 193 includes PCRI values for a visual dataset associated with multiple CVMs 140. PCRI data 193 may include an index or mapping that maps the stored PCRI values to particular CVMs 140, visual datasets, and/or tasks.

The task data 194 includes stored information related to instructions or prompts used by the ML pipeline configuration engine 110. For example, the task data 194 may include instructions, ground truths, prompts, contexts, or the like. The task data 194 may include metadata about the tasks generated and/or executed by the ML pipeline configuration engine 110, such as time, location, source, etc.

In one or more embodiments, the CVM data 195 includes outputs, prompts, metadata, parameters, hyperparameters, and/or other data related to the one or more CVMs 140. The CVM data 195 may include various metrics for CVMs 140 that are based on the CVMs' 140 performance history and/or that are based on PCRI values. The CVM data 195 may also include metadata such as time, location, source, version number, etc.

The deployment criterion data 196 includes data related to deployment criteria used to determine whether or not to deploy a particular CVM 140 and/or if a CVM 140 is a candidate for being deployed to a particular deployment setting. The deployment criterion data 196 may include criteria for determining whether or not to deploy a CVM 140 to a deployment setting based on a type of a task and/or a PCRI value for the CVM 140.

In an embodiment, the ML pipeline configuration system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

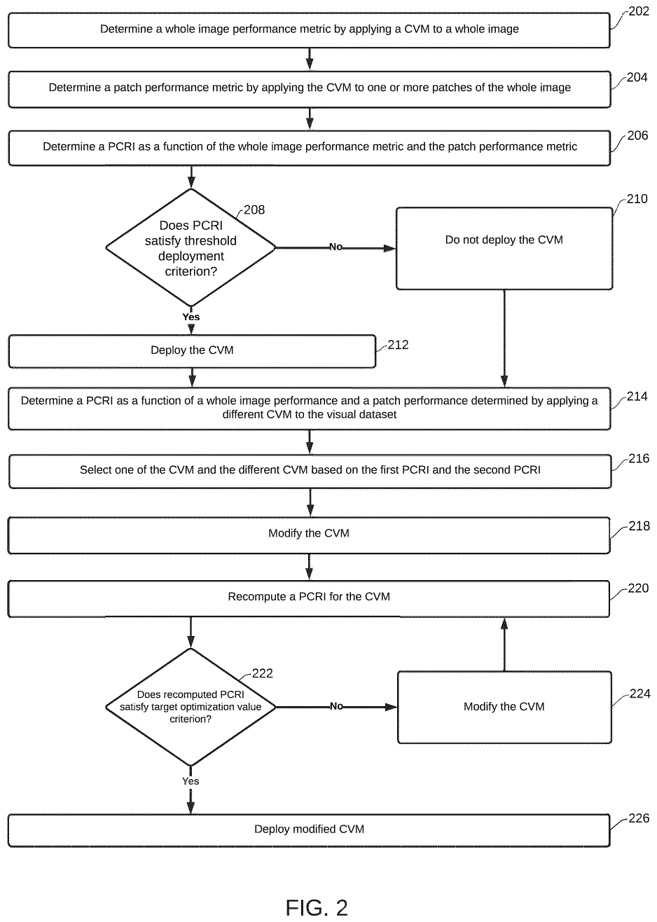

In one or more embodiments, the ML pipeline configuration engine 110 refers to hardware and/or software configured to perform operations described herein for configuring a CVM or other ML pipeline. Examples of operations for an ML pipeline configuration engine 110 and/or other components of the ML pipeline configuration system 100 are described below with reference to FIG. 2.

### 4. OPERATIONS FOR CONFIGURING AN ML PIPELINE

FIG. 2 illustrates an example set of operations for configuring an ML pipeline in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

For ease of discussion, operations are described below as being performed by components of the system 100 of FIG. 1. Alternatively or additionally, some or all of the operations may be performed by another system.

In an embodiment, an ML pipeline configuration engine determines a whole image performance metric by applying a CVM to a whole image (Operation 202). For example, the ML pipeline configuration engine may instruct a CVM to perform one or more tasks using a whole image version of an image. The ML pipeline configuration engine may instruct one or more models to perform one or more tasks for multiple whole images included in a dataset. The ML pipeline configuration engine may determine an accuracy, precision, correctness, F1 score, and/or other performance metric based on the result(s) of performing the task(s) using the whole image(s).

The ML pipeline configuration engine determines a patch performance metric by applying the CVM to one or more patches of the whole image (Operation 204). In an embodiment, the ML pipeline configuration engine instructs the CVM to perform one or more tasks using the one or more patches of the whole image. The ML pipeline configuration engine may instruct one or more CVMs to perform tasks on patches of whole images included in a dataset. The ML pipeline configuration engine may determine an accuracy, precision, correctness, F1 score, and/or other performance metric based on the result(s) of performing the task(s) using the whole image(s). The ML pipeline configuration engine may determine a maximum patch performance and/or an average patch performance. A maximum patch performance is determined by identifying the highest valued performance metrics among patch-specific performance metrics associated with an image. An average patch performance is determined by identifying an average performance for patch locations for a set of images. A maximum average patch performance is determined by identifying a patch location with a highest average patch performance for a set of images.

The ML pipeline configuration engine determines a PCRI value as a function of the whole image performance metric and the patch performance metric (Operation 206). The ML pipeline configuration engine may determine a ratio or value based on one or more patch performance scores and one or more whole image performance scores. One or more embodiments formulate a PCRI value by determining a quotient of (a) a patch score for an image divided by (b) a whole image score for the image. In one or more embodiments, the ML pipeline configuration engine determines a PCRI value by subtracting the quotient from unity (from one). Additionally, or alternatively, one or more embodiments determine a PCRI value by determining a positive or negative value computed by subtracting the quotient from unity.

One or more embodiments determine a PCRI value by subtracting a whole image score or whole image performance metric from a (maximum or average) patch performance score or patch performance metric. Additionally, or alternatively, one or more embodiments determine a PCRI value as the absolute value of subtracting a whole image score from a patch performance score. One or more embodiments define a PCRI value as (1) the difference between a whole image score and a patch performance score divided by (2) a score or metric for the whole image. One or more embodiments calculate a normalized PCRI value by multiplying the quotient by a normalization factor. In an embodiment, the normalization factor is proportional to the number of patches or the square of the number of patches. One or more embodiments formulate a PCRI value by subtracting the whole image score from the patch performance score, subtracting the patch performance score from the whole image score, and/or dividing a positive or negative difference between the patch performance score and whole image performance score by the whole image performance score.

The ML pipeline configuration engine determines if the PCRI value satisfies a threshold deployment criterion (Operation 208). For example, the ML pipeline configuration engine may determine if the PCRI value indicates sensitivity to contextual noise. In an embodiment, the PCRI value indicates sensitivity to contextual noise if the PCRI value is above a threshold value (e.g., above 0, above 0.1, above 0.5, or another value). In some embodiments, the PCRI value indicates robustness to contextual noise if the PCRI value is near zero (e.g., below 0.01, 0.1, below 0.2, or below another threshold value). In some embodiments, the ML pipeline configuration engine determines if a maximum-based PCRI value satisfies a threshold deployment criterion and/or if an average-based PCRI value satisfies a threshold deployment criterion. The threshold deployment criteria for a maximum-based PCRI value and an average-based PCRI value may be the same threshold criteria or different threshold criteria.

If the PCRI value does not satisfy the threshold deployment criterion, the ML pipeline configuration engine does not deploy the CVM (Operation 210). For example, the ML pipeline configuration engine may compare one or more PCRI values for a CVM to one or more threshold criteria. In this example, deploying the CVM requires a minimum level of robustness to contextual noise. The ML pipeline configuration engine may not deploy a CVM with a PCRI value that does not meet a threshold criterion corresponding to the minimum level of robustness.

If the PCRI value satisfies the threshold deployment criterion, the ML pipeline configuration engine deploys the CVM (Operation 212). The ML pipeline configuration engine may determine if one or more threshold deployment criteria are satisfied based on one or more PCRI values associated with a CVM. For example, one or more embodiments may deploy a CVM to a deployment setting responsive to determining that a maximum patch performance-based PCRI value for the CVM satisfies a threshold criterion and/or responsive to determining that an average patch performance based PCRI value satisfies a threshold criterion. One or more embodiments deploy a visual encoder to a deployment setting responsive to determining that the PCRI value for the visual encoder satisfies one or more general and/or task type-specific threshold criteria.

The ML pipeline configuration engine determines another PCRI value for another CVM (Operation 214). Specifically, the ML pipeline configuration engine may determine another PCRI value as a function of another CVM's whole image performance and patch performance on the same task and/or for the same visual dataset.

The ML pipeline configuration engine selects an CVM based on multiple CVMs' respective PCRI values (Operation 216). In an embodiment, the ML pipeline configuration engine compares the PCRI values to determine which CVM is better suited for a deployment setting. For example, one or more embodiments may select the CVM having a PCRI value closer to zero and/or having the lower PCRI value. In one or more embodiments, a PCRI value is associated with a particular task type. For example, a PCRI value for yes/no question answering tasks may be different than a PCRI value for captioning tasks. One or more embodiments select the CVM having a PCRI value for a task type closer to zero and/or having the lower PCRI value.

The ML pipeline configuration engine modifies the CVM (Operation 218). In an embodiment, the ML pipeline configuration engine fine-tunes or adapts the CVM. For example, the ML pipeline configuration engine may fine-tune or adapt the CVM for a particular task using a particular dataset aligned to the task. In one or more embodiments, the ML pipeline configuration engine modifies a language encoder, a vision encoder, and/or an attention mechanism of the CVM by modifying one or more parameters associated with the encoder or mechanism.

The ML pipeline configuration recomputes a PCRI value for the CVM (Operation 220). The ML pipeline configuration may use the modified CVM to perform one or more tasks using one or more visual datasets and recomputed one or more PCRI values for the CVM. One or more embodiments recompute a PCRI value using one or more same tasks and/or one or more same visual datasets as the PCRI value that was computed before modifying the CVM.

The ML pipeline configuration engine determines if the recomputed PCRI value satisfies a target optimization value criterion (Operation 222). In an embodiment, the ML pipeline configuration engine compares the recomputed PCRI value with a target optimization value to determine if the recomputed PCRI value satisfies the criterion. For example, the ML pipeline configuration may determine if a recomputed maximum-based PCRI value for the modified CVM is less than a threshold distance from zero and/or if a recomputed average based PCRI value for the modified CVM is less than a threshold distance from zero.

If the recomputed PCRI value does not satisfy the target optimization value criterion, the ML pipeline configuration engine modifies the CVM (Operation 224). Specifically, one or more embodiments further modify the CVM rather than deploying the CVM. After modifying the CVM again, the ML pipeline configuration engine may recompute a PCRI value for the modified CVM and determine if the recomputed PCRI value for the modified CVM satisfies the target optimization value criterion. This process may continue for a number of iterations or until a recomputed PCRI value for a modified CVM satisfies the target optimization value criterion.

If the recomputed PCRI value satisfies the target optimization value criterion, the ML pipeline configuration engine deploys the modified CVM (Operation 226). In this example, the ML pipeline configuration engine deploys a modified CVM responsive to determining that the modified CVM satisfies one or more target optimization value criterion. In one or more embodiments, a target optimization value criterion includes a target maximum patch performance-based PCRI value threshold criterion and/or a target average patch performance-based PCRI value threshold criterion. In one or more embodiments, the target optimization criteria include a whole image performance threshold criterion, a maximum patch performance threshold criterion, and/or an average patch performance criterion threshold criterion. Responsive to determining that one or more such criteria for deploying a CVM to a deployment setting is/are satisfied, the ML pipeline configuration engine deploys the modified CVM to the deployment setting.

### 5. PERFORMANCE METRICS FOR CVM PIPELINE CONFIGURATION SYSTEM

Detailed examples are described below for purposes of clarity. Components and/or operations described below should be understood as specific examples which may not be applicable to certain embodiments. Accordingly, components and/or operations described below should not be construed as limiting the scope of any of the claims.

### 5.1. Patch Granularity Performance Metrics

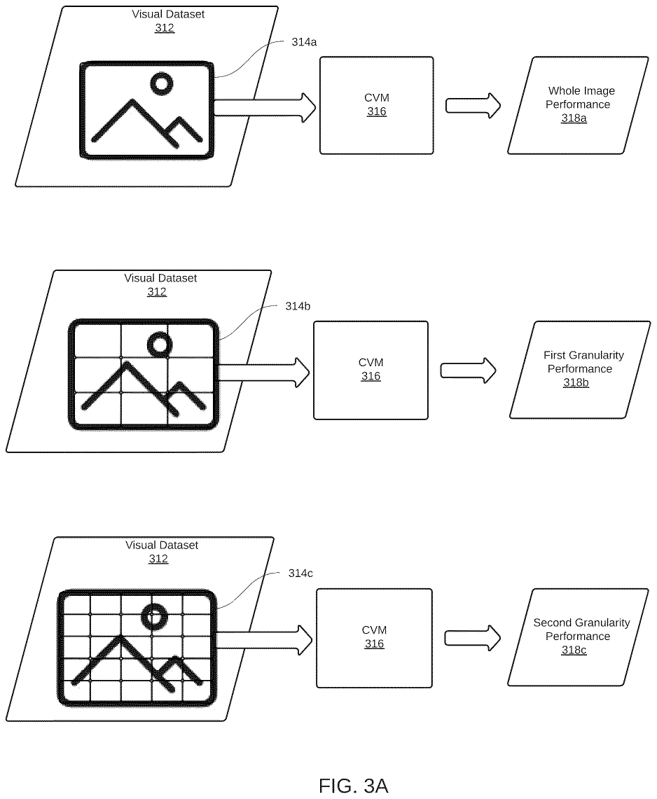

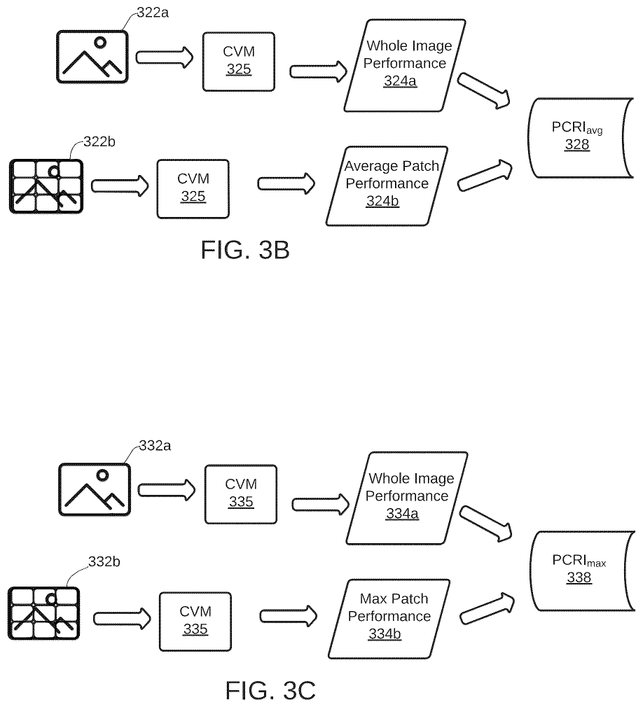

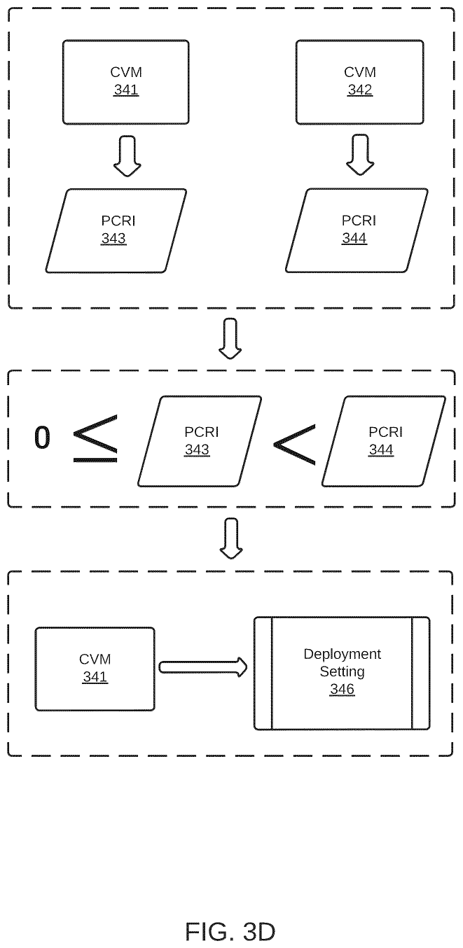

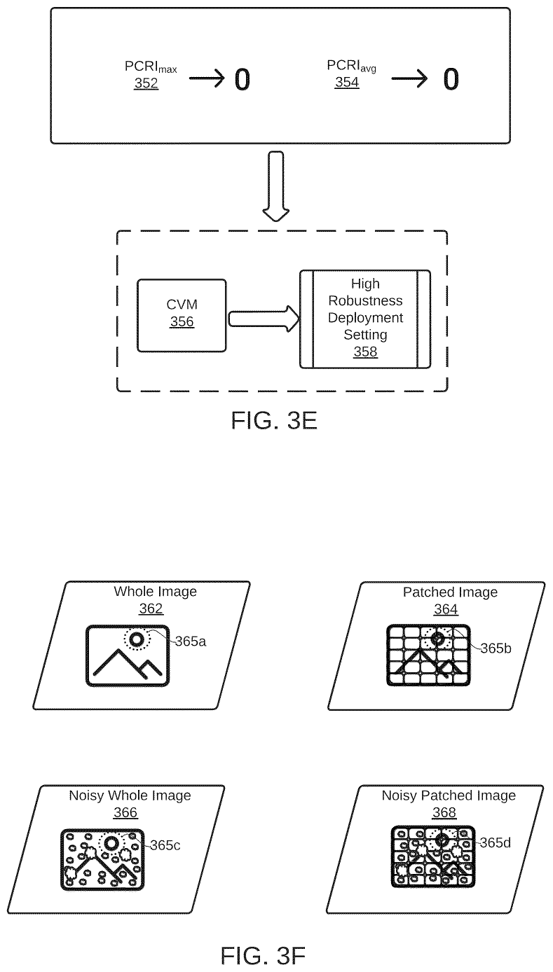

FIG. 3A illustrates an example of determining performance metrics from an image and from patches of the image at different granularities. In FIG. 3A, an ML pipeline configuration engine generates a performance metric from a whole image version 314a included in a visual dataset 312. In FIG. 3A, the ML pipeline configuration engine determines performance metrics for the whole image and for the whole image at different granularities. In this example, the different granularities include a whole image version 314a of the image, a nine-patch (9-patch) granularity version 314b, and a twenty-five-patch (25-patch) granularity version 314c.

The ML pipeline configuration engine generates a whole image performance metric 318a for a CVM 316 that is based on a whole image version 314a of an image included in the visual dataset. In this example, the ML pipeline configuration engine also generates a first granularity performance metric 318b for the CVM 316 that is based on the nine-patch granularity version 314b of the image, and the ML pipeline configuration engine generates a second granularity performance metric 318c for the CVM 316 that is based on the 25-patch granularity version 314c of the image.

The CVM 316 performs one or more tasks using the whole image version 314a of the image, the nine-patch granularity version 314b, and/or the 25-patch granularity version 314c. The ML configuration engine evaluates a response generated by the CVM 316 for a task using the whole image version 314a to determine a metric (e.g., accuracy, F1 score, etc.) that is used to calculate the whole image performance metric 318a. The ML pipeline configuration engine evaluates a response generated by the CVM 316 for a task using the nine-patch granularity version 314b to determine a metric that is used to calculate the first granularity performance metric 318b. The ML pipeline configuration engine evaluates a response generated by the CVM 316 for a task using the 25-patch granularity version 314c to determine a metric that is used to calculate the second granularity performance metric 318c.

### 5.2. Average Patch Context Robustness Index

FIG. 3B illustrates an example of calculating an average-based PCRI value (PCRI_{avg}). In FIG. 3B, a whole image version 322a of an image is provided to a CVM 325 as a context for performing one or more tasks. The CVM 325 generates results that are scored to determine a whole image performance metric 324a. A patched version 322b of the image is also provided to the CVM 325 as a context for performing the one or more tasks. The CVM 325 generates results that are scored to determine an average patch performance metric 324b.

In this example, an average-based PCRI value, PCRI_{avg} 328, is computed according to the following formula:

$${PCRI}_{( avg , n )} = α \cdot ( {\overline{P}}_{patch , n} - {P}_{whole} ) / {P}_{whole}$$

where:
P̅_{patch,n} is the average performance across the n×n patches;
P_{whole} represents performance on the full image (n=1); and
α=n\hat{ }2 normalizes for the number of patches.

As illustrated in FIG. 3B, the patched version 322b of the image has n=3, α=9. The PCRI_{avg} 328 for the CVM 325 is calculated using the based on the P̅_{patch,n} and P_{whole} as formulated above.

Additionally, or alternatively, an average-based PCRI value, PCRI_{avg}, is computed according to the following formula:

$${PCRI}_{( avg , n )} = α \cdot ( {P}_{whole} - {\overline{P}}_{patch , n} ) / {P}_{whole}$$

Additionally, or alternatively, an average-based PCRI value, PCRI_{avg}, is computed according to the following formula:

$${PCRI}_{( avg , n )} = α \cdot \pm ( \vert {P}_{whole} - {\overline{P}}_{patch , n} \vert ) / {P}_{whole}$$

where ±|P_{whole}−P̅_{patch,n}| is the positive or negative absolute value of P_{whole}−P̅_{patch,n}

### 5.3. Maximum Patch Context Robustness Index

FIG. 3C illustrates calculation of a maximum-based PCRI value (PCRIₘₐₓ). In FIG. 3B, a whole image version 332a of an image is provided to a CVM 335 as a context for performing one or more tasks. The CVM 335 generates results that are scored to determine a whole image performance metric 334a. A patched version 332b of the image is also provided to the CVM 335 as a context for performing the one or more tasks. The CVM 335 generates results that are scored to determine a maximum patch performance metric 334b.

In this example, a maximum-based PCRI value, PCRIₘₐₓ 338, is computed according to the following formula:

$${PCRI}_{( max , n )} = α \cdot ( max ( {P}_{patch , n} ) - {P}_{whole} ) / {P}_{whole}$$

where max(P_{patch,n}) is the maximum performance across the n×n patches, P whole represents performance on the full image (n=1); and α=n\hat{ }2 normalizes for the number of patches.

As illustrated in FIG. 3C, the patched version 332b of the image has n=3, α=9. The PCRIₘₐₓ 338 for the CVM 335 is calculated using the based on the P̅_{patch,n} and P_{whole} as formulated above. In some embodiments, a composite-based PCRI value is computed as a composite or weighted function of one or more other PCRI values, such as a PCRI_{avg} or PCRIₘₐₓ.

Additionally, or alternatively, a maximum-based PCRI value, PCRIₘₐₓ, is computed according to the following formula:

$${PCRI}_{( max , n )} = α \cdot ( {P}_{whole} - max ( {P}_{patch , n} ) ) / {P}_{whole}$$

where max(P_{patch,n}) is the maximum performance across the n×n patches, P_{whole} represents performance on the full image (n=1), and α=n\hat{ }2 normalizes for the number of patches.

Additionally, or alternatively, a maximum-based PCRI value, PCRIₘₐₓ, is computed according to the following formula:

$${PCRI}_{( max , n )} = α \cdot ( \pm \vert {P}_{whole} - max ( {P}_{patch , n} ) \vert ) / {P}_{whole}$$

where ±|P_{whole}−max(P_{patch,n})| is the positive or negative absolute value of P_{whole}−max(P_{patch,n}).

### 5.4. Patch Context Robustness Index

In an embodiment a PCRI value is computed according to the following formula:

$${PCRI}_{( n )} = 1 - ( {P}_{patch , n} / {P}_{whole} )$$

where P_{patch,n} is the maximum performance achieved (per sample) from a sample of patches from an n×n grid of patches of a full image, and P_{whole} is the performance achieved from using the full image.

In this example, the system computes one or more PCRI values, PCRI₍ₙ₎, to assess robustness of a CVM. Additionally, or alternatively, the system computes one or more values of PCRI₍ₙ₎ using respective tasks of one or more different types. The system assesses the robustness of a CVM by analyzing one or more task type-specific PCRI values. For example, using the formula:

$${PCRI}_{( n )} = 1 - ( {P}_{patch , n} / {P}_{whole} ) ,$$

one or more embodiments categorize a CVM as follows:
PCRI₍ₙ₎≈0 indicates that the CVM is robust and performs well on full image and patches.
PCRI₍ₙ₎<0 indicates that global context distracts the CVM and the CVM is not robust to irrelevant background context.
PCRI₍ₙ₎>0 and/or PCRI₍ₙ₎≤1 indicates that the CVM needs global context to solve the task. The PCRI value indicates the patches omit needed information.
PCRI₍ₙ₎<<0 or undefined indicates that whole image performance approaches zero. Whole image performance approaching zero indicates that the tasks performed by the CVM are not solvable using a whole image.

Alternatively, for the formula:

$${PCRI}_{( n )} = ( {P}_{patch , n} / {P}_{whole} ) ,$$

one or more embodiments categorize a CVM as follows:
PCRI₍ₙ₎≈1 indicates that the CVM is robust and performs well on full image and patches.
PCRI₍ₙ₎>1 indicates that global context distracts the CVM; The CVM is not robust to irrelevant background context.
PCRI₍ₙ₎>0 and/or PCRI₍ₙ₎≤1 indicates that the CVM needs global context to solve the task. The PCRI value indicates the patches omit needed information.
PCRI₍ₙ₎>>∞ indicates that whole image performance approaches zero. Whole image performance approaching zero indicates that the tasks performed by the CVM are not solvable using a whole image.

One or more embodiments use a PCRI₍ₙ₎ calculated based on one or more patch scores and one or more whole image scores for a particular task type to classify a robustness of a CVM performing tasks of the particular type.

One or more embodiments compute PCRI₍ₙ₎ by applying an additive or subtractive constant, a coefficient, hyperparameter, and/or an absolute value function to a PCRI₍ₙ₎. For example, in one or more embodiments, one or more values of PCRI₍ₙ₎s are defined as:

$${PCRI}_{( n )} = 1 - ( {P}_{patch , n} / {P}_{whole} )$$

$$and / or as :$$

$${PCRI}_{( n )} = ( {P}_{patch , n} / {P}_{whole} ) .$$

### 5.5. CVM Pipeline Deployment

FIG. 3D illustrates an example of deploying a CVM to a deployment setting by an ML pipeline configuration engine. In FIG. 3D, a CVM 341 is used to determine a PCRI value 343 for the CVM 341. Another CVM 342 is used to determine a PCRI value 344 for CVM 342.

In this example, PCRI value 343 is determined according to the results of CVM 341 performing a set of tasks on a visual dataset, and PCRI value 344 is determined according to the results of CVM 342 performing the set of tasks on the visual dataset. The ML pipeline configuration engine calculates PCRI value 343 based on a performance metric for a whole image and a performance metric for a patched version of the whole image. The ML pipeline configuration engine calculates PCRI value 344 based on a performance metric for the whole image and a performance metric for a patched version of the whole image. For example, the ML pipeline configuration engine may calculate PCRI value 343 based on whole image performance and patch performance for CVM 341 when performing a set of tasks on a visual dataset. The ML pipeline configuration engine calculates PCRI value 344 based on whole image and patch performance for CVM 342 when performing the set of tasks on the visual dataset.

In FIG. 3D, PCRI value 343 is greater than or equal to zero, and PCRI value 344 is greater than zero. Also, PCRI value 343 is less than PCRI value 344. Because PCRI value 343 is less than PCRI value 344, PCRI value 343 is greater than or equal to zero, and/or PCRI value 344 is greater than zero, the ML pipeline configuration engine selects CVM 341 for deployment to a target deployment setting 346. The ML pipeline configuration engine configures an ML pipeline, so a subsequent visual language task is forwarded to CVM 341.

### 5.6. High Robustness CVM Pipeline Deployment

FIG. 3E illustrates a deployment of a CVM 356 to a high robustness deployment setting 358. In FIG. 3E, an ML pipeline configuration engine has calculated a value of PCRIₘₐₓ 352 and a value of PCRI_{avg} 354 for a CVM 356.

In this example,

$${PCRI}_{( max , n )} = α \cdot ( max ( {P}_{patch , n} ) - {P}_{whole} ) / {P}_{whole}$$

### for CVM 356 and

$${PCRI}_{( avg , n )} = α \cdot ( {\overline{P}}_{patch , n} - {P}_{whole} ) / {P}_{whole}$$

### for CVM 356.

For the formulae above, a CVM is robust to contextual noise if P̅_{patch,n}≈P_{whole} and max(P̅_{patch,n})≈P_{whole}, so PCRI_{avg,n}≈0 and PCRI_{max,n}≈0. In an embodiment, such a CVM filters irrelevant information, maintaining consistent performance across context. On the other hand, a CVM is context-sensitive if P̅_{patch,n}>P_{whole} and max(P_{patch,n})>>P_{whole}, so PCRI_{avg,n}>0 and PCRI_{max,n}>>0. In an embodiment, such a CVM sometimes struggles with full-image noise. This sort of CVM yields better performance when focused on clean, localized patches.

In the example of FIG. 3E, PCRIₘₐₓ 352 and PCRI_{avg} 354 are both near zero. Because both PCRIₘₐₓ 352 and PCRI_{avg} 354 are near zero, CVM 356 satisfies deployment criteria for the high robustness deployment setting 358. Responsive to determining that CVM 356 satisfies the deployment criteria for the high robustness deployment setting 358, the ML pipeline configuration engine deploys CVM 356 to the high robustness deployment setting 358.

### 5.7. Noisy Patch Context Robustness Performance

FIG. 3F illustrates an example of noisy patch context robustness performance. In FIG. 3F, an ML pipeline configuration engine divides a whole image 362 into patches, to generate a clean patched image 364 of the source whole image 362. The ML pipeline configuration engine applies noise to the whole image 362 to generate a noisy whole image 366. The ML pipeline configuration engine applies noise to the clean patched image 364 to obtain a noisy patched image 368.

In this example, an area 368a of the whole image 362 includes information necessary to answer a visual reasoning question. For example, a visual reasoning question may include a text prompt asking, “What color is the sun in this image?” The portion of the picture with the sun includes the information necessary to answer the visual reasoning question. In general, the least amount of noise is present when the portion of an image including necessary information is considered without other portions of the image. Adding noise and/or other irrelevant contextual information to an image increases the strain on a CVM's attention mechanism. A CVM that is not robust does not perform well in the presence of such noise or other irrelevant contextual information.

In this example, the whole image 362 includes a portion or area 365a that includes information necessary or helpful to answer or complete a visual reasoning task (or other visual language task). Likewise, an area 365b of the patched image 364 includes the information to answer the task. In this example, the noisy whole image 366 includes an area 365c that includes the information to answer or complete the task, and the noisy patched image 368 includes an area 365d that includes the information to answer or complete the task.

One or more embodiments use an ML pipeline configuration engine to apply noise to the whole image 362 and/or to the clean patched image 364. In some embodiments, the ML pipeline configuration engine does not apply noise to the areas 365a-d that include the information to answer or complete the task. Since noise is not applied to the areas 365a-d that include the information, the absolute answerability of the visual reasoning task is not directly affected. However, the presence of the irrelevant information or noise added to the noised images increases the difficulty of visual reasoning tasks for CVMs that are sensitive to contextual information.

One or more embodiments calculate a PCRI value for a CVM using the whole image 362 and the clean patched image 364. One or more embodiments calculate a PCRI value for the CVM is calculated using the noisy whole image 366 and the noisy patched image 368. The ML pipeline configuration engine compares the PCRI values to determine a difference. In one or more embodiments, an amount of noise is quantified. In one or more embodiments, the ML pipeline configuration engine records the rate of change in the difference in PCRI values relative to the amount of noise applied as an indicated of robustness for the CVM.

In one or more embodiments, the ML pipeline configuration engine determines (a) the rate of change in the difference in PCRI values relative to the amount of noise applied as an indication of a CVM's robustness to noise and/or (b) the rate of change in the difference in PCRI values relative to the amount of noise applied as an indication of a CVM's sensitivity to noise. The ML pipeline configuration engine selects one of the CVMs responsive to determining that a CVM has a lesser rate of change in the presence of increased noise.

### 6. ML ARCHITECTURE

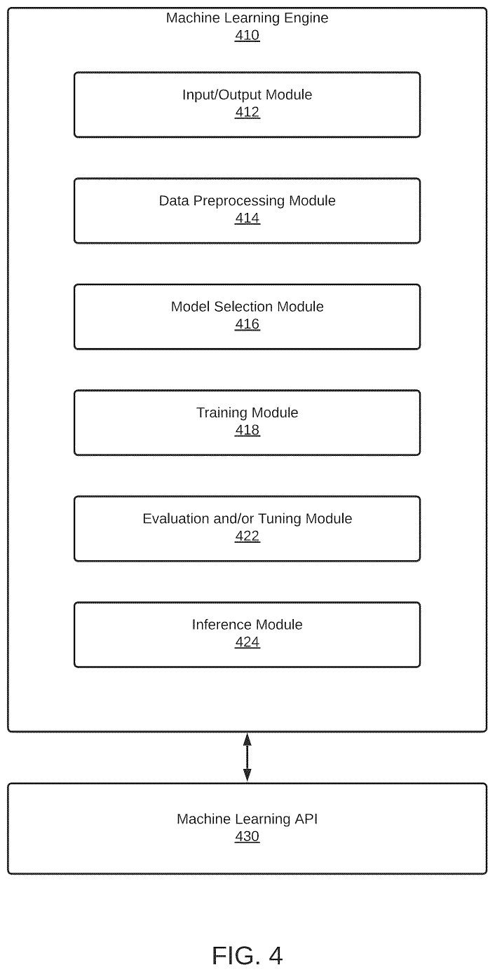

FIG. 4 illustrates a ML engine 410 in accordance with one or more embodiments. As illustrated in FIG. 4, ML engine 410 includes input/output module 412, data preprocessing module 414, model selection module 416, training module 418, evaluation and/or tuning module 422, and inference module 424.

In accordance with an embodiment, input/output module 412 serves as the primary interface for data entering and exiting the system, managing the flow and integrity of data. This module may accommodate a wide range of data sources and formats to facilitate integration and communication within the ML architecture.

In an embodiment, an input handler within input/output module 412 includes a data ingestion framework capable of interfacing with various data sources, such as databases, Application Programming Interfaces (API) s, file systems, and real-time data streams. This framework is equipped with functionalities to handle different data formats (e.g., CSV, JSON, XML) and efficiently manage large volumes of data. It includes mechanisms for batch and real-time data processing that enable the input/output module 412 to be versatile in different operational contexts whether processing historical datasets or streaming data.

In accordance with an embodiment, input/output module 412 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the ML process.

In an embodiment, an output handler within input/output module 412 includes an output framework designed to handle the distribution and exportation of outputs, predictions, or insights. Using the output framework, input/output module 412 formats these outputs into user-friendly and accessible formats, such as reports, visualizations, or data files, compatible with other systems. Input/output module 412 also ensures secure and efficient transmission of these outputs to end-users or other systems in an embodiment and may employ encryption and secure data transfer protocols to maintain data confidentiality.

In accordance with an embodiment, data preprocessing module 414 transforms data into a format suitable for use by other modules in ML engine 410. For example, data preprocessing module 414 may transform raw data into a normalized or standardized format suitable for training ML models and for processing new data inputs for inference. In an embodiment, data preprocessing module 414 acts as a bridge between the raw data sources and the analytical capabilities of ML engine 410.

In an embodiment, data preprocessing module 414 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods, like imputation or removal of incomplete records, depending on the nature and volume of the missing data. Data preprocessing module 414 may be configured to handle anomalies in different ways, depending on context. Data preprocessing module 414 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 414 includes a feature encoding framework that ensures categorical variables are transformed into a format that can be easily interpreted by ML algorithms. Techniques, such as one-hot encoding or label encoding, may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 414 processes new data for inference, data preprocessing module 414 replicates the same preprocessing steps to ensure consistency with the training data format. This helps to avoid discrepancies between the training data format and the inference data format, thereby reducing the likelihood of inaccurate or invalid model predictions.

In an embodiment, model selection module 416 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 416 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 416 utilizes techniques from the field of Automated Machine Learning (AutoML). AutoML systems automate the process of model selection by rapidly prototyping and evaluating multiple models. They use various techniques, like Bayesian optimization, genetic algorithms, or reinforcement learning, to explore the model space efficiently. Model selection module 416 may use these techniques to evaluate each candidate model based on performance metrics relevant to the task. For example, accuracy, precision, recall, or F1 score may be used for classification tasks, and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. Mean squared error measures the average squared difference between the actual and predicted values, providing an indication of the model's accuracy. A lower MSE may indicate a model's greater accuracy in predicting values, for it represents a smaller average discrepancy between the actual and predicted values.

In accordance with an embodiment, model selection module 416 also considers computational efficiency and resource constraints. This is meant to help ensure the selected model is both accurate and practical in terms of computational and time requirements. In an embodiment, certain features of model selection module 416 are configurable such as a configured bias toward (or against) computational efficiency.

In accordance with an embodiment, training module 418 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 418 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 418 manages overfitting, where a model learns the training data too well, including its noise and outliers, at the expense of its ability to generalize to new data. Techniques, such as regularization, dropout (in neural networks), and early stopping, are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 418 includes logic to handle different types of data and learning tasks. For instance, it includes different training routines for supervised learning (where the training data comes with labels) and unsupervised learning (without labeled data). In the case of deep learning models, training module 418 also manages the complexities of training neural networks that include initializing network weights, choosing activation functions, and setting up neural network layers.

In an embodiment, evaluation and/or tuning module 422 incorporates dynamic feedback mechanisms and facilitates continuous model evolution to help ensure the system's relevance and accuracy as the data landscape changes. Evaluation and/or tuning module 422 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and/or tuning module 422 performs continuous model tuning by using hyperparameter optimization. Evaluation and/or tuning module 422 performs an exploration of the hyperparameter space using algorithms, such as grid search, random search, or more sophisticated methods like Bayesian optimization. Evaluation and/or tuning module 422 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and/or tuning module 422 integrates data feedback and updates the model. Evaluation and/or tuning module 422 actively collects feedback from the model's real-world applications, an indicator of the model's performance in practical scenarios. Such feedback can come from various sources, depending on the nature of the application. For example, in a user-centric application, like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and/or tuning module 422 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and/or tuning module 422 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 424 transforms raw data into actionable, precise, and contextually relevant predictions. In addition to processing and applying a trained model to new data, inference module 424 may also include post-processing logic that refines the raw outputs of the model into meaningful insights.

In an embodiment, inference module 424 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 424 transforms the outputs of a trained model into definitive classifications. Inference module 424 employs the underlying model as a tool to generate probabilistic outputs for each potential class. It then engages in an interpretative process to convert these probabilities into concrete class labels.

In an embodiment, when inference module 424 receives the probabilistic outputs from the model, it analyzes these probabilities to determine how they are distributed across some or every potential class. If the highest probability is not significantly greater than the others, inference module 424 may determine that there is ambiguity or interpret this as a lack of confidence displayed by the model.

In an embodiment, inference module 424 uses thresholding techniques for applications where making a definitive decision based on the highest probability might not suffice due to the critical nature of the decision. In such cases, inference module 424 assesses if the highest probability surpasses a certain confidence threshold that is predetermined based on the specific requirements of the application. If the probabilities do not meet this threshold, inference module 424 may flag the result as uncertain or defer the decision to a human expert. Inference module 424 dynamically adjusts the decision thresholds based on the sensitivity and specificity requirements of the application, subject to calibration for balancing the trade-offs between false positives and false negatives.

In accordance with an embodiment, inference module 424 contextualizes the probability distribution against the backdrop of the specific application. This involves a comparative analysis, especially in instances where multiple classes have similar probability scores, to deduce the most plausible classification. In an embodiment, inference module 424 may incorporate additional decision-making rules or contextual information to guide this analysis, ensuring that the classification aligns with the practical and contextual nuances of the application.

In regression models, where the outputs are continuous values, inference module 424 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 424 incorporates domain-specific adjustments into its post-processing routine. This involves tailoring the model's output to align with specific industry knowledge or contextual information. For example, in financial forecasting, inference module 424 may adjust predictions based on current market trends, economic indicators, or recent significant events, ensuring that the outputs are both statistically accurate and practically relevant.

In an embodiment, inference module 424 includes logic to handle uncertainty and ambiguity in the model's predictions. In cases where inference module 424 outputs a measure of uncertainty, such as in Bayesian inference models, inference module 424 interprets these uncertainty measures by converting probabilistic distributions or confidence intervals into a format that can be easily understood and acted upon. This provides users with both a prediction and an insight into the confidence level of that prediction. In an embodiment, inference module 424 includes mechanisms for involving human oversight or integrating the instance into a feedback loop for subsequent analysis and model refinement.

In an embodiment, inference module 424 formats the final predictions for end-user consumption. Predictions are converted into visualizations, user-friendly reports, or interactive interfaces. In some systems, like recommendation engines, inference module 424 also integrates feedback mechanisms, where user responses to the predictions are used to continually refine and improve the model, creating a dynamic, self-improving system.

The ML engine API 430 is an interface that facilitates access to and interaction with the ML engine 410 by other modules and/or components of a system. In an embodiment, ML engine API 430 allows for applications to leverage ML engine 410. In an embodiment, ML engine API 430 may be built on a RESTful architecture and offer stateless interactions over standard HTTP/HTTPS protocols. ML engine API 430 may feature a variety of endpoints, each tailored to a specific function within ML engine 410. In an embodiment, endpoints such as “/submitData” facilitate the submission of new data for processing, while endpoints such as “/retrieveResults” fetch the outcomes of data analysis or model predictions. Message level encryption (MLE) API also includes endpoints, such as “/updateModel” for model modifications and “/trainModel” to initiate training with new datasets.

In an embodiment, ML engine API 430 is equipped to support SOAP-based interactions. This extension involves defining a Web Services Description Language (WSDL) document that outlines the API's operations and the structure of request and response messages. In an embodiment, ML engine API 430 supports various data formats and communication styles. In an embodiment, ML engine API 430 endpoints may handle requests in JSON format or any other suitable format. For example, ML engine API 430 may process XML, and it may also be engineered to handle more compact and efficient data formats, such as Protocol Buffers or Avro, for use in bandwidth-limited scenarios.

In an embodiment, ML engine API 430 is designed to integrate WebSocket technology for applications necessitating real-time data processing and immediate feedback. This integration enables a continuous, bi-directional communication channel for a dynamic and interactive data exchange between the application and ML engine 410.

### 7. ML OPERATIONS

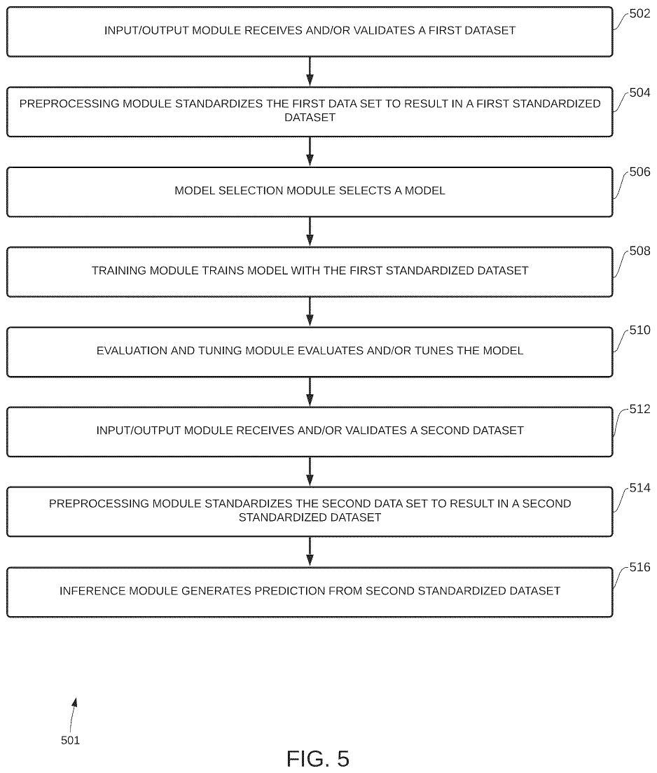

FIG. 5 illustrates a set of ML operations 501. In some embodiments, one or more operations of the set of operations 500 is performed by an ML engine such as ML engine 410. In an embodiment, input/output module 412 receives a dataset intended for training (Operation 502). This data can originate from diverse sources, like databases or real-time data streams, and in varied formats, such as CSV, JSON, or XML. Input/output module 412 assesses and validates the data, ensuring its integrity by checking for consistency, data ranges, and types.

In an embodiment, training data is passed to data preprocessing module 414. Here, the data undergoes a series of transformations to standardize and clean it, making it suitable for training ML models (Operation 504). This involves normalizing numerical data, encoding categorical variables, and handling missing values through techniques like imputation.

In an embodiment, prepared data from the data preprocessing module 414 is then fed into model selection module 416 (Operation 506). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 418 trains the selected model with the prepared dataset (Operation 508). It implements learning algorithms to adjust the model's internal parameters, optimizing them to identify patterns and relationships in the training data. Training module 418 also addresses the challenge of overfitting by implementing techniques, like regularization and early stopping, ensuring the model's generalizability.

In an embodiment, evaluation and/or tuning module 422 evaluates the trained model's performance using the validation dataset (Operation 510). Evaluation and/or tuning module 422 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 412 receives a dataset intended for inference. Input/output module 412 assesses and validates the data (Operation 512).

In an embodiment, data preprocessing module 414 receives the validated dataset intended for inference (Operation 514). Data preprocessing module 414 ensures that the data format used in training is replicated for the new inference data, maintaining consistency and accuracy for the model's predictions.

In an embodiment, inference module 424 processes the new dataset intended for inference, using the trained and tuned model (Operation 516). It applies the model to this data, generating raw probabilistic outputs for predictions. Inference module 424 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

### 8. GENERATIVE ARTIFICIAL INTELLIGENCE MODELS

A generative model is an ML model that is capable of generating new data instances based on the data used to train the model. A generative model may be referred to as a “generative AI model.” Generative models learn the underlying distribution of the training data, enabling them to produce new instances of data that share properties with the original dataset. This capability makes them particularly useful in a variety of applications, including image and voice generation, text synthesis, and more sophisticated tasks, such as unsupervised learning, semi-supervised learning, and domain adaptation.

Large language models are designed to understand, generate, and interpret human language by processing extensive collections of data. The foundational architecture behind LLMs is the transformer network, a type of neural network that excels in handling sequential data such as text. Unlike certain architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers including a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to other elements is calculated using a scaled dot-product attention function that computes the attention scores by taking the dot product of the query vector with the key vectors, dividing each by the square root of the dimension of the key vectors to scale the scores, then applying a “SoftMax” function to obtain the weights for the value vectors. The scaled dot-product attention function is applied independently by each head in the multi-head, self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 412, when used for LLMs, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 414 in the context of LLMs may include steps, such as normalization, where the text is converted to a uniform case, and punctuation is standardized. This process ensures that the model treats similar words or symbols consistently, reducing the complexity of the input space. Additionally, techniques, such as sentence segmentation, may be applied to manage longer texts, enabling the model to process information in chunks that align with natural language structures.

In accordance with one or more embodiments, model selection module 416, when used for LLMs, involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 418, when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware, such as Graphics Processing Units (GPUs) or Tensor Processing Units (TPUs), to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and/or tuning module 422 assesses the performance of LLMs using metrics, such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 424, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). An LMM is an advanced ML model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for numerous applications, such as image captioning, text-to-image generation, image-to-text generation, visual question answering, and more, where understanding the relationship between different data types is crucial. By leveraging diverse datasets during training, LMMs learn to create coherent and contextually relevant outputs across various modalities, enhancing their utility in complex, real-world scenarios.

The architecture of LLMs combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of LMMs. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In LMMs, data preprocessing is a step that ensures the input data is in a suitable format for the model to process. This involves tasks, such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training LMMs involves optimizing their parameters through exposure to diverse datasets that include paired data from different modalities. This computationally intensive process often requires specialized hardware, like GPUs or TPUs, to manage the large volumes of data and the complexity of the model calculations. Techniques, such as dropout and layer normalization, are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and/or tuning of LMMs are conducted using various metrics tailored to the specific tasks they are designed to perform. For example, Bilingual Evaluation Understudy scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in ML by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides LLMs and LMMs belong to the broad category of generative models. For example, stochastic models directly incorporate randomness into their structure, making them inherently generative, for they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are designed for generating new data points by learning a distribution of some input data, by encoding inputs into a latent space, and/or by generating outputs by sampling from a latent space. An example VAE is therefore inherently generative. Sequence-to-sequence models are generative in nature when used with sampling strategies. Although this list of generative model types is not exhaustive, it illustrates the broad use of the term generative model beyond LLMs.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 9. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 10. MICROSERVICE APPLICATIONS

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 11. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

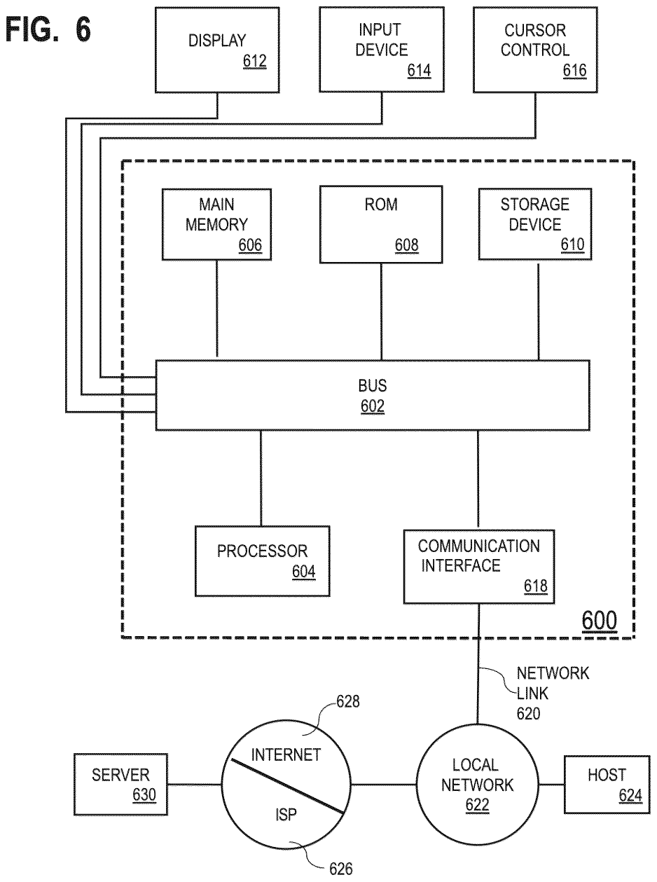

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 12. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
generating a first patch context robustness index (PCRI) value that quantifies, for a computer vision model (CVM), a first sensitivity of the first CVM to contextual noise, at least by:
determining a first performance metric at least by applying the first CVM to a first whole image;
determining a second performance metric at least by applying the first CVM to a first plurality of patches of the first whole image at a first granularity;
determining the first PCRI value as a function of at least the first performance metric and the second performance metric;
determining if the first PCRI value satisfies a criterion for deploying the first CVM to a machine learning (ML) pipeline; and
responsive to determining that the first PCRI value satisfies the criterion for deploying the first CVM to the ML pipeline: deploying the first CVM to the ML pipeline;
wherein the method is performed by at least one device including a hardware processor.

2. The method of claim 1, wherein determining if the first PCRI value satisfies the criterion for deploying the first CVM to the ML pipeline comprises determining if the first PCRI value satisfies a threshold value criterion.

3. The method of claim 1, further comprising:
generating a second PCRI value that quantifies, for a second CVM, a second sensitivity of the second CVM to contextual noise; and
selecting one of the first CVM or the second CVM for the ML pipeline, based at least on the first PCRI value and the second PCRI value.

4. The method of claim 3, wherein selecting one of the first CVM or the second CVM for the ML pipeline, based at least on the first PCRI value and the second PCRI value, comprises:
determining a context-sensitivity ranking of at least the first CVM and the second CVM, based at least on the first PCRI value and the second PCRI value; and
selecting one of the first CVM or the second CVM based at least on the context-sensitivity ranking.

5. The method of claim 1, further comprising:
iteratively modifying the first CVM and recomputing the first PCRI value, to optimize for a target value of the first PCRI value.

6. The method of claim 1, further comprising:
generating the first whole image from a source image at least by adding noise to the source image.

7. The method of claim 1, wherein determining the first PCRI value comprises:
computing a quotient of (a) at least a difference obtained by subtracting the first performance metric from the second performance metric and (b) at least the first performance metric; and
determining the first PCRI value based at least in part on the quotient.

8. The method of claim 1, further comprising:
determining a third performance metric at least by applying the first CVM to a second whole image;
determining a fourth performance metric at least by applying the first CVM to a second plurality of patches of the second whole image at the first granularity;
determining a second PCRI value as a function of at least the third performance metric and the fourth performance metric; and
determining an aggregated PCRI value for the first CVM based at least on the first PCRI value and the second PCRI value.

9. The method of claim 1, wherein determining the second performance metric comprises determining an average of the first CVM's performance across respective patches in the first plurality of patches.

10. The method of claim 1, wherein determining the second performance metric comprises determining a maximum of the first CVM's performance across respective patches in the first plurality of patches.

11. The method of claim 1, wherein applying the first CVM to one or more of the first whole image or the first plurality of patches comprises prompting the first CVM to perform one or more of: a yes/no question task; a multiple-choice question task; a visual question answering task; a captioning task; a diagram understanding task; a compositional reasoning task; an optical character recognition task; or a logical reasoning task.

12. The method of claim 1:
wherein determining the first PCRI value is based at least on an average of the first CVM's performance across respective patches in the first plurality of patches;
the method further comprising:
determining a second PCRI value based at least on a maximum of the first CVM's performance across respective patches in the first plurality of patches;
determining if the first PCRI value satisfies a first threshold criterion for average performance;
determining if the second PCRI value satisfies a second threshold criterion for maximum performance;
wherein deploying the first CVM to the ML pipeline is performed responsive to determining that the first PCRI value satisfies the first threshold criterion and the second PCRI value satisfies the second threshold criterion.

13. The method of claim 1, further comprising:
determining the criterion based on a visual language task type, the criterion comprising a threshold PCRI value for the visual language task type; and
responsive to the first PCRI value satisfying the criterion, selecting a visual encoder associated with the first CVM to perform a task of the visual language task type; and
performing the task using the visual encoder.

14. The method of claim 1, wherein the first plurality of patches of the first whole image at the first granularity comprises a division of the first whole image into a first number of columns of patches and a second number of rows of patches.

15. The method of claim 1, wherein the first plurality of patches comprises non-overlapping patches of the first whole image that are equal in size.

16. One or more non-transitory computer readable media comprising instructions which, when executed by one or more hardware processors, cause performance of operations comprising:
generating a first patch context robustness index (PCRI) value that quantifies, for a first computer vision model (CVM), a first sensitivity of the first CVM to contextual noise, at least by:
determining a first performance metric at least by applying the first CVM to a first whole image;
determining a second performance metric at least by applying the first CVM to a first plurality of patches of the first whole image at a first granularity;
determining the first PCRI value as a function of at least the first performance metric and the second performance metric;
determining if the first PCRI value satisfies a criterion for deploying the first CVM to an ML pipeline; and
responsive to determining that the first PCRI value satisfies the criterion for deploying the first CVM to the ML pipeline: deploying the first CVM to the ML pipeline.

17. The computer readable media of claim 16, wherein determining if the first PCRI value satisfies the criterion for deploying the first CVM to the ML pipeline comprises determining if the first PCRI value satisfies a threshold value criterion.

18. The computer readable media of claim 16, further comprising:
generating a second PCRI value that quantifies, for a second CVM, a second sensitivity of the second CVM to contextual noise;
selecting one of the first CVM or the second CVM for the ML pipeline, based at least on the first PCRI value and the second PCRI value.

19. A system, comprising:
one or more hardware processors;
one or more non-transitory computer-readable media; and
program instructions stored on the one or more non-transitory computer-readable media which, when executed by the one or more hardware processors, cause the system to perform operations comprising:
generating a first patch context robustness index (PCRI) value that quantifies, for a first computer vision model (CVM), a first sensitivity of the first CVM to contextual noise, at least by:
determining a first performance metric at least by applying the first CVM to a first whole image;
determining a second performance metric at least by applying the first CVM to a first plurality of patches of the first whole image at a first granularity;
determining the first PCRI value as a function of at least the first performance metric and the second performance metric;
determining if the first PCRI value satisfies a criterion for deploying the first CVM to an ML pipeline; and
responsive to determining that the first PCRI value satisfies the criterion for deploying the first CVM to the ML pipeline: deploying the first CVM to the ML pipeline.

20. The system of claim 19, the operations further comprising:
generating a second PCRI value that quantifies, for a second CVM, a second sensitivity of the second CVM to contextual noise;
selecting one of the first CVM or the second CVM for the ML pipeline, based at least on the first PCRI value and the second PCRI value.
